(19) United States
(12) Patent Application Publication
(10) Pub. No.: US 2025/0094776 A1
(43) Pub. Date: Mar. 20, 2025

(54) METHOD, ELECTRONIC DEVICE, AND PROGRAM PRODUCT FOR GENERATING MACHINE LEARNING MODEL

(71) Applicant: Dell Products L.P., Round Rock, TX (US)

(72) Inventors: Zijia Wang, Weifang (CN); Yufeng Wang, Shanghai (CN); Chunxi Chen, Shanghai (CN); Zhen Jia, Shanghai (CN)

(21) Appl. No.: 18/484,731

(22) Filed: Oct. 11, 2023

(30) Foreign Application Priority Data
Sep. 15, 2023 (CN) 202311198552.3

(51) Int. Cl. G06N 3/0455

(52) U.S. Cl. CPC G06N 3/0455

(57) ABSTRACT

Embodiments of the present disclosure relate to a method for generating a machine learning model. The method includes: encoding a decision tree using a graph neural network; inputting the encoded decision tree into a machine learning model; generating a question corresponding to each node of a root node and internal nodes of the decision tree using the machine learning model; inputting a natural language text to the machine learning model; and generating the machine learning model using the inputted natural language text and the generated question. According to embodiments of the present disclosure, a machine learning model that enables faster and more accurate provision of corresponding solutions based on the inputted natural language text can be realized.

### RELATED APPLICATION

The present application claims priority to Chinese Patent Application No. 202311198552.3, filed Sep. 15, 2023, and entitled “Method, Electronic Device, and Program Product for Generating Machine Learning Model,” which is incorporated by reference herein in its entirety.

### FIELD

Embodiments of the present disclosure relate to a method, an electronic device, and a computer program product for generating a machine learning model.

### BACKGROUND

Decision tree is a widely used decision analysis method. It has a hierarchical tree structure consisting of a root node, edges, internal nodes, and leaf nodes. In machine learning, a decision tree is a prediction model that represents a mapping relationship between object attributes and object values. Decision trees are widely used in many fields such as medicine, healthcare, and education and are used to make complex decisions based on a set of rules or criteria.

Typically, decision trees can be applied to customer service, but conventional approaches to using decision trees for customer service have some limitations and drawbacks. For example, a technician would need to manually navigate a decision tree by asking a customer each question based on each branch of the decision tree, which can be tedious and inefficient. The technician agent needs to adapt the questions and answers corresponding to the decision tree to the natural language and interpret them according to the situation of the customer, which can be challenging.

### SUMMARY

Embodiments of the present disclosure relate to a method, an electronic device, and a computer program product for generating a machine learning model.

According to a first aspect of the present disclosure, a method for generating a machine learning model is provided, comprising: encoding a decision tree using a graph neural network; inputting the encoded decision tree into a machine learning model; generating a question corresponding to each node of a root node and internal nodes of the decision tree using the machine learning model; inputting a natural language text to the machine learning model; and generating the machine learning model using the inputted natural language text and the generated question.

According to a second aspect of the present disclosure, an electronic device for generating a machine learning model is provided. The electronic device comprises: a processor; and a memory, the memory being coupled to the processor and storing instructions, wherein the instructions, when executed by the processor, cause the electronic device to perform the following actions: encoding a decision tree using a graph neural network; inputting the encoded decision tree into a machine learning model; generating a question corresponding to each node of a root node and internal nodes of the decision tree using the machine learning model; inputting a natural language text to the machine learning model; and generating the machine learning model using the inputted natural language text and the generated question.

According to a third aspect of the present disclosure, a computer program product is provided. The computer program product is tangibly stored on a non-transitory computer-readable medium and comprises machine-executable instructions, wherein the machine-executable instructions, when executed by a machine, cause the machine to perform steps of the method in the first aspect of the present disclosure.

### BRIEF DESCRIPTION OF THE DRAWINGS

By description of example embodiments of the present disclosure, provided in more detail herein with reference to the accompanying drawings, the above and other objectives, features, and advantages of the present disclosure will become more apparent. In the example embodiments of the present disclosure, the same reference numerals generally represent the same elements.

FIG. 1 illustrates a schematic diagram of an example environment in which a device and/or a method of embodiments of the present disclosure can be implemented.

FIG. 2 illustrates a flow chart of a method for generating a machine learning model according to embodiments of the present disclosure.

FIG. 3 illustrates a flow chart of a method for training a machine learning model according to embodiments of the present disclosure.

FIG. 4 illustrates a schematic diagram of a decision tree according to embodiments of the present disclosure.

FIG. 5 illustrates a schematic diagram of questions generated by a machine learning model and a decision chain according to embodiments of the present disclosure.

FIG. 6 illustrates a flow chart of a method of adjusting a machine learning model using a decision tree and a decision chain according to embodiments of the present disclosure.

FIG. 7 illustrates a schematic diagram of a scenario of use of a trained machine learning model according to embodiments of the present disclosure.

FIG. 8 illustrates a block diagram of an example device that can be used to implement embodiments of the present disclosure.

### DETAILED DESCRIPTION

Illustrative embodiments of the present disclosure will be described in more detail below with reference to the accompanying drawings. While some specific embodiments of the present disclosure are shown in the accompanying drawings, it should be understood that the present disclosure may be implemented in various forms, and should not be construed as being limited to the embodiments set forth herein. Rather, these embodiments are provided to make the present disclosure more thorough and complete and to fully convey the scope of the present disclosure to those skilled in the art.

The term “include” and variants thereof used in this text indicate open-ended inclusion, that is, “including but not limited to. “Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated.

When applying decision trees to customer service, a technician needs to perform manual matching on corresponding nodes in the decision tree according to the text that is inputted by a customer and to find a scheme that matches the text that is inputted by the customer from the decision tree, which easily leads to errors and requires a large amount of labor costs when the decision tree is complex, making it very difficult to provide satisfactory service to the customer.

Based on the above problem, the present application provides a method for generating a machine learning model. This method encodes a decision tree through a graph neural network and inputs the encoded decision tree into the machine learning model, then causes the machine learning model to generate a question that corresponds to each node of the root node and the internal nodes of the decision tree, and finally generates the machine learning model using the natural language text and the decision tree. The resulting machine learning model generated by this method can provide appropriate schemes faster, more accurately, and more satisfactorily based on the inputted text.

In addition, when applying this machine learning model to customer service, the machine learning model has many advantages over the above-described approach of applying a decision tree to customer service. For example, the technician does not need to store or look up a decision tree for each server model and configuration because it is already encoded into the machine learning model and thus it can be retrieved more easily and quickly. The technician does not need to manually navigate the decision tree by asking each question based on each branch of the decision tree.

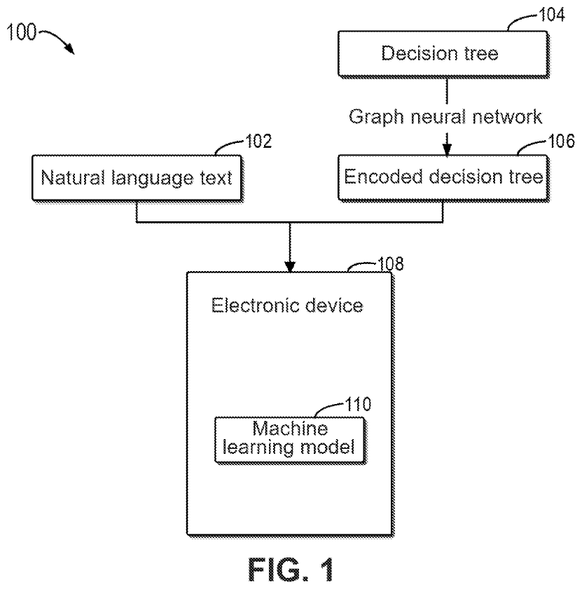

Fundamental principles and a plurality of example embodiments of the present disclosure will be described in detail below with reference to the accompanying drawings. FIG. 1 illustrates a schematic diagram of an example environment 100 in which a device and/or a method of embodiments of the present disclosure can be implemented.

FIG. 1 includes natural language text 102, a decision tree 104, an encoded decision tree 106, an electronic device 108, and a machine learning model 110. The machine learning model 110 is also referred to in some embodiments herein as a target machine learning model. It should be understood that the types and numbers of models, the data transmission process, the arrangement, etc., illustrated in FIG. 1 are merely examples, and that the example environment 100 may include different numbers of models arranged in different ways, data transmission processes, various additional elements, and the like. It should be understood that the above examples are only intended to be illustrative of the application of the target machine learning model 110. As technology evolves, the target machine learning model 110 can include a variety of known or unknown applications in various fields and aspects.

In the example environment 100, the target machine learning model 110 may be installed in any electronic device having processing computing resources or storage resources. For example, the electronic device may have common capabilities such as receiving and sending data requests, real-time data analysis, local data storage, real-time network connectivity, and the like. The electronic device may typically include various types of devices. Examples of the electronic device may include, but are not limited to, desktop computers, laptop computers, smartphones, wearable devices, security devices, smart manufacturing devices, smart home devices, Internet of Things devices, smart cars, drones, and the like, which is not limited in the present disclosure in any way.

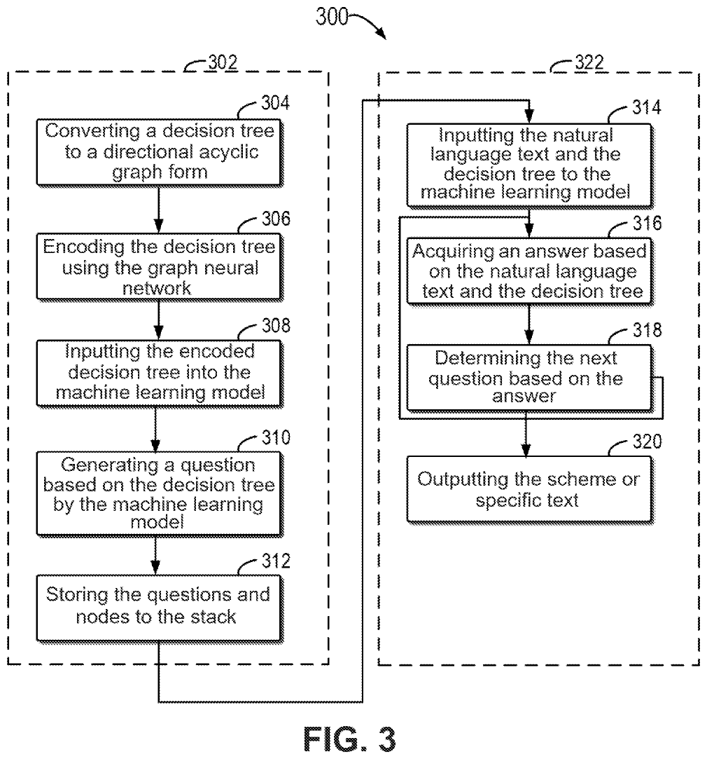

According to embodiments of the present disclosure, the machine learning model 110 may be a machine learning model that includes, for example, a large language model such as GPT-3. As shown in FIG. 1, the machine learning model 110 is trained by inputting the encoded decision tree 106 and the natural language text 102 to the machine learning model 110 that is included in the electronic device 108. Here, the encoded decision tree 106 is obtained by encoding the decision tree 104 using a graph neural network. The specific encoding approach will be explained in detail in the description with respect to FIG. 3.

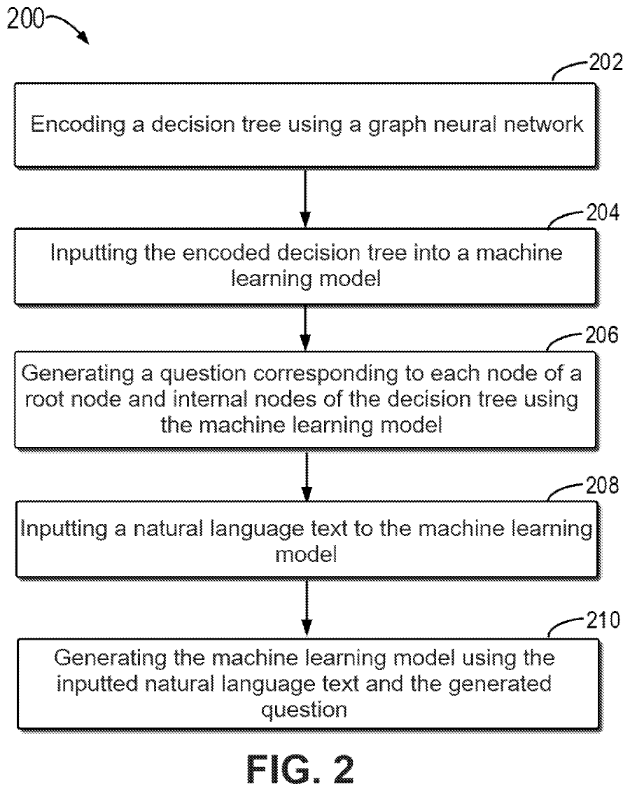

FIG. 2 illustrates a flow chart of a method 200 for generating a machine learning model according to embodiments of the present disclosure. The machine learning model 110 as shown in FIG. 1 can be generated by the method 200 in FIG. 2.

At block 202, a decision tree is encoded using a graph neural network. In some embodiments, the decision tree is converted to be in a directional acyclic graph (DAG) form. The decision tree in the directional acyclic graph form is then encoded using the graph neural network so that it can be input into the machine learning model as an embedding of the machine learning model.

At block 204, the encoded decision tree is inputted into a machine learning model. In some embodiments, the encoded decision tree may be inputted as an embedding directly to the machine learning model after being encoded using the graph neural network, or it may be inputted as an embedding along with the natural language text to the machine learning model while the step of block 208 is performed. At this point, the embedding that is inputted to the machine learning model contains information about all edges and all nodes of the decision tree.

At block 206, a question corresponding to each node of a root node and internal nodes of the decision tree is generated using the machine learning mode. In this embodiment, the decision tree includes leaf nodes, internal nodes, and a root node, wherein the leaf nodes are nodes with the highest depth in the decision tree, and each leaf node includes a scheme that may be relevant to the natural language text. In other embodiments, it is also possible to only generate questions that correspond to some nodes in the root node and the internal nodes of the decision tree, respectively.

At block 208, natural language text is inputted to the machine learning model. In some embodiments, the natural language text may include information that corresponds to a portion of the questions generated at block 206. It may also not include information corresponding to any of the questions generated at block 206.

At block 210, the machine learning model is generated using the inputted natural language text and the generated question. The machine learning model generated in the above manner can provide schemes faster, more accurately, and more satisfactorily based on the inputted text. This clearly can enhance the performance and efficiency of various types of customer services and increase the comfort level of customers when using them.

Embodiments of the present disclosure will be described in detail below in conjunction with FIGS. 3 to 7. For ease of understanding, specific embodiments mentioned in the following description are all examples and are not intended to limit the protection scope of the present disclosure. It should be understood that embodiments described below may also include additional actions not shown and/or may omit actions shown, and the scope of the present disclosure is not limited in this regard.

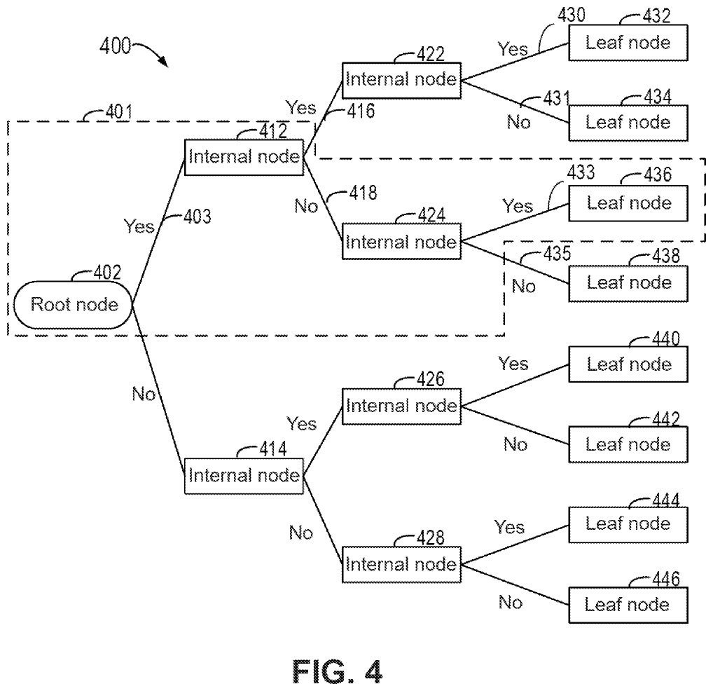

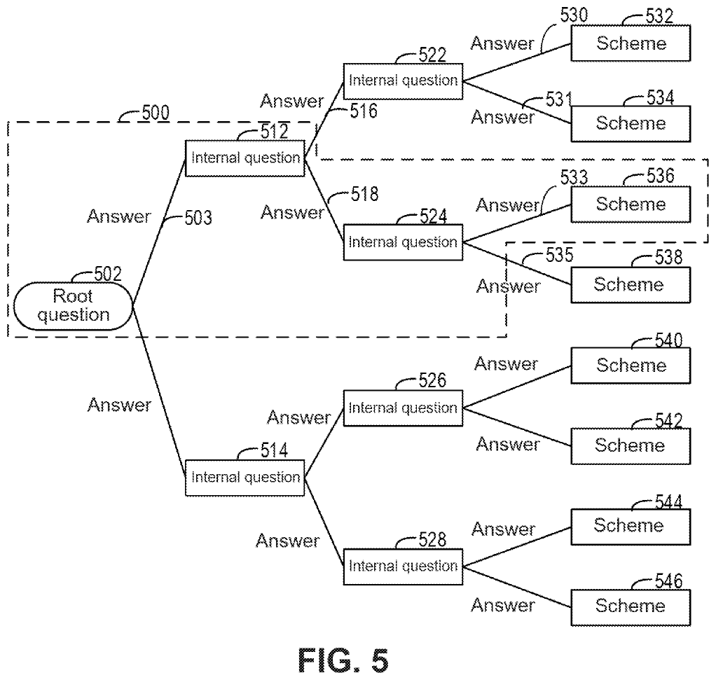

FIG. 3 illustrates a flow chart of a method for training a machine learning model according to embodiments of the present disclosure. FIG. 4 illustrates a schematic diagram of a decision tree according to embodiments of the present disclosure. FIG. 5 illustrates a schematic diagram of questions generated by a machine learning model and a decision chain according to embodiments of the present disclosure. For the purpose of clearly setting forth embodiments of the present disclosure, these illustrative embodiments are described herein in conjunction with FIGS. 3 to 5.

As shown in FIG. 3, according to some embodiments, a method 300 for training a machine learning model includes a pre-training process 302 and an inference process 322.

At a first step 304 in the pre-training process 302, a decision tree 400 (referring to FIG. 4) is converted to a directional acyclic graph form.

Before further description of step 304, the structure of the decision tree is described with reference to FIG. 4. As shown in FIG. 4, the decision tree 400 includes a root node 402, a plurality of internal nodes 412, 414, 422, 424, 426, and 428, and a plurality of leaf nodes 432, 434, 436, 438, 440, 442, 444, and 446. The root node 402 is a node with a minimum depth in the decision tree 400, and a leaf node is a node with a maximum depth in the decision tree 400. The depth of the nodes increases gradually from the root node to the leaf nodes. The nodes are connected to one another by edges (e.g., 403, 416, 418, 430, 431, 433, 435, etc.), wherein each leaf node contains a scheme for solving the respective target question. The decision tree 400 illustrated in FIG. 4 is only an example, and the number and structure of nodes may be modified as desired.

Now, returning to step 304 of FIG. 3, in order to input the decision tree 400 shown in FIG. 4 as an embedding into the machine learning model, it is necessary to convert the decision tree into a directional acyclic graph of the form G=(V, E). Here, V is the node set, and E is the edge set. The node set represents the set of the root node and all internal nodes. The edge set represents the set of all edges in the decision tree. Each node v∈V has an associated label lᵥ indicating the rule or criterion used to make the decision, and each edge e=(u, v)∈E has an associated label lₑ indicating the possible result or choice of the rule or criterion at node u. The root node r∈V is the starting point of the decision making process, while the leaf nodes are final schemes or decisions.

After performing step 304, a step 306 of encoding the decision tree using the graph neural network is performed. Specifically, in order to encode the decision tree into a compact and meaningful representation that can be fed into a machine learning model (e.g., a large language model such as GPT-3), the decision tree, which has been converted into the directional acyclic graph form, is encoded using a graph neural network (GNN) that can learn node embeddings based on the graph structure and node labels. The GNN consists of two main parts: a message passing function and an aggregation function. The message passing function calculates the message for each node based on the embeddings of its adjacent nodes (which are adjacent in the depth direction) and the associated labels of the edges, and the aggregation function updates the embedding of each node by aggregating the messages from its adjacent nodes. The message passing and aggregation functions are applied iteratively for a fixed number of steps or until convergence. Formally, let hᵥ^{t} denote the embedding of node v at step t, and let hₑ denote the embedding of edge e. Furthermore, hᵥ⁰=f(lᵥ) and hₑ=g(lₑ) are initialized, where f and g are some embedding functions (e.g., one-hot encoding or word embedding). Then, at each step t, the following is calculated:

$$\begin{matrix}{m}_{v}^{t} = {\sum }_{u ∈ N ( v )} {h}_{u}^{t - 1} ⊙ {h}_{( u , v )} , {h}_{v}^{t} \\ = σ ( {Wm}_{v}^{t} + b )\end{matrix} \qquad ( Equation 1 )$$

where N(v) is the set of adjacent nodes of node v, ⊙ is the element-by-element product, σ is a nonlinear activation function (e.g., ReLU), and W and b are learnable parameters. After the step T, the final node embedding hᵥ^{T} for each node v∈V can be obtained.

After obtaining the final node embedding hᵥ^{T} for each node v∈V at step 306, step 308 of inputting the encoded decision tree into the machine learning model is performed. That is, the embedding hᵥ^{T} is input into the machine learning model.

Next, a step 310 of generating a question based on the decision tree by the machine learning model is executed. Specifically, the machine learning model generates natural language questions corresponding to the root node 402 and all internal nodes in the decision tree 400, respectively, based on the inputted node embedding hᵥ^{T}. As previously mentioned, an example of the machine learning model may be GPT-3. GPT-3 is a large-scale pre-trained language model capable of generating coherent and varied text given some initial notation or cues. As an example only, using GPT-3 as a conditional text generator, natural language questions corresponding to the root node 402 and all internal nodes in the decision tree 400, respectively, are generated based on the node embedding hᵥ^{T}. As shown previously, GPT-3 may also only generate questions that correspond to some nodes in the root node and the internal nodes of the decision tree, respectively. As an embodiment, the machine learning model may be generated in a depth-first manner starting with the question corresponding to the root node. At each node, the machine learning model uses some predefined templates or formats (e.g., “Is . . . ?,” “What is . . . ?,” and “How . . . ?”). For example, if the root node 402 in FIG. 4 is “Age>18,” the machine learning model may generate a root question 502, as illustrated in FIG. 5, such as “Is this person's age 18 or above?”.

Notably, the encoded decision tree inputted in step 308 includes information about the leaf nodes of the decision tree, but in step 310, only questions of the root and internal nodes of the decision tree are generated. The questions generated in step 310 are shown in FIG. 5.

Referring to FIG. 5, the root question 502 generated by the machine learning model corresponds to the root node 402 of the decision tree 400 of FIG. 4, the internal question 512 corresponds to the internal node 412, and similarly, the internal nodes 414, 422, 424, 426, and 428 correspond to the internal questions 514, 522, 524, 526, and 528, respectively. Also, the edges 403, 416, 418, 430, 431, 433 and 435 correspond to answers 503, 516, 518, 530, 531, 533 and 535, respectively. However, the machine learning model does not generate questions corresponding to the leaf nodes, and internal questions at the highest depth still point to the schemes included in the leaf nodes in FIG. 4, respectively. That is, the internal question 522 points to schemes 532 and 534, the internal question 524 points to schemes 536 and 538, the internal question 526 points to schemes 540 and 542, and the internal question 528 points to schemes 544 and 546.

After generating the natural language questions corresponding to the root node 402 and all internal nodes in the decision tree 400, a step 312 of storing the questions and nodes (such as the root node 402 in FIG. 4 and the root question 502 in FIG. 5) to the stack is performed.

Steps 304, 306, 308, 310, and 312 are referred to as pre-training steps, and the machine learning model after the execution of these steps completes the pre-training and is capable of executing an output scheme incorporating natural language text.

At step 314, the natural language text and the decision tree are input to the machine learning model. Specifically, the root node embedding is concatenated with the natural language text embedding to form a combined input for use in the machine learning model:

$$x = [ {h}_{v}^{T} ; {e}_{t} ] \qquad ( Equation 2 )$$

where eₜ is an embedding of natural language text obtained through some pre-trained language models (e.g., BERT). However, since the node embedding hᵥ^{T} has already been input to the machine learning model during the pre-training process 302, it is also possible to input only the natural language text embedding eₜ at step 314.

The machine language model can acquire an answer based on the natural language text and the decision tree (step 316) after receiving the inputted x. The illustration continues here with the example of the root question 502 “Is this person's age 18 or above?” generated in step 310. If the inputted natural language text is “Alice is a 19-year old student who has been vaccinated and is not allergic to the vaccine.”, the machine learning model can acquire the answer 503 “Yes, Alice's age is 18 or above” based on the natural language text.

After acquiring the answer 503, a step 318 of determining the next question based on the answer is performed. Since the answer 503 corresponds to the edge 403 in the decision tree 400, the next question is an internal question 512 corresponding to the internal node 412. For example, the internal node 412 may be “vaccine allergy,” the corresponding internal question 512 is “Is this person allergic to the vaccine?” and then steps 316 and 318 are repeated until a leaf node in the decision tree is reached, or until a situation is encountered where the answer to the current question fails to be obtained from the inputted natural language text.

The illustration continues with the example of the inputted natural language text of “Alice is a 19-year old student who has been vaccinated and is not allergic to the vaccine.” The machine learning model obtains, from the natural language text of “Alice is a 19-year old student who has been vaccinated and is not allergic to the vaccine,” an answer 518 “No, Alice is not allergic to the vaccine” related to the internal question 512 “Is this person allergic to the vaccine?” as illustrated. Since the answer 518 corresponds to the edge 418 in the decision tree 400, it is determined that the next question is the internal question 524 “Has this person been vaccinated?” corresponding to the internal node 424 “Vaccinated.” The machine learning model obtains from the natural language text an answer 533 “Yes, Alice has been vaccinated” related to the internal question 524. At this point, since the answer 533 corresponds to the edge 433 connected to the leaf node 436, the leaf node in the decision tree has been reached. If the natural language text inputted to the machine learning model is “Alice is a 19-year old student who is not allergic to the vaccine,” the answer to the internal question 524 “Has this person been vaccinated?” fails to be obtained from that natural language text. Therefore, the next step is performed to output the scheme or specific text (step 320).

At step 320, for the case of arriving at a leaf node in the decision tree, in this example, the outputted scheme may be a scheme 536 “not suitable for vaccination” corresponding to the leaf node 436. For the case where an answer to the current question fails to be obtained from the inputted natural language text, the specific text outputted may be “Sorry, it is not possible to determine whether the vaccination is suitable.”

The question generated during the execution of steps 316 and 318, the node corresponding to the question, and the answer may be output as a sequence of notations y=[y₁, y₂, . . . , yₙ].

The method for generating a machine learning model illustrated through FIGS. 3 to 5 is not only easy to operate, but also has the advantages of fast retrieval and high accuracy. In order to further improve the quality and accuracy of the scheme provided based on the inputted natural language text, some other embodiments of the present disclosure further provide a technical solution for further adjusting the machine learning model using a decision tree and a decision chain.

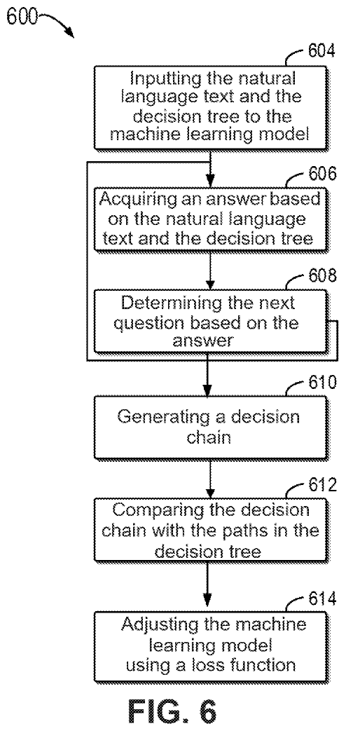

A method 600 for adjusting a machine learning model using a decision tree and a decision chain is specifically illustrated below with reference to FIG. 6. Steps 604, 606, and 608 in FIG. 6 correspond to steps 314, 316, and 318 in FIG. 3, respectively. Therefore, the description is not repeated here.

After repeating the step 606 of acquiring the answer based on the natural language text and the decision tree and the step 608 of determining the next question based on the answer until a leaf node in the decision tree is reached, or until a situation is encountered where the answer to the current question fails to be obtained from the inputted natural language text, a decision chain is generated that contains all of the questions determined and all of the answers corresponding to the questions (step 610). An example of such an arrangement is shown as generated decision chain 500 in FIG. 5.

The generated decision chain 500 is then compared with all the paths in the decision tree 400 (step 612). The paths in the decision tree 400 represent all nodes and edges included from the root node to any of the leaf nodes. Specifically, by parsing questions and answers into triplets in the form of (s, p, o), a decision chain is output from the machine learning model, where s is the subject, p is the predicate, and o is the object. For example, for the root question 502 “Is the person's age 18 or below?” and the answer “Yes, Alice's age is 18 or above,” two triplets can be generated: (person, age, >18) and (Alice, age, >18). Then, by discovering whether there exists the same path as the generated decision chain, the generated decision chain is compared with the original decision tree. For example, if the original decision tree has paths like (r, age>18, v₁) and (v₁, v₂, unsuitable for vaccination), where r is the root node and v₁ and v₂ are some internal nodes (the internal node 412 and the internal node 422), the generated decision chain can be checked to see if it contains these triplets. If yes, it is judged that the generated questions and answers are correct and consistent with the decision tree. Otherwise, it is judged that there exist some errors or inconsistency in the generation process. As can be seen in conjunction with FIGS. 4 and 5, the decision chain 500 is consistent with the path 401 of the decision tree 400. Therefore, it is judged that the questions and answers generated this time are correct.

Next, a step 614 of adjusting the machine learning model using a loss function is performed. Specifically, the comparison in step 612 is used as a loss function to guide the training of the machine learning model. The parameters of the machine learning model and the graph neural network are updated by using back propagation and gradient descent, so as to minimize differences between the generated knowledge graph and the original decision tree. As an alternative embodiment, some auxiliary loss functions, such as cross entropy or perturbation, may also be used to measure the fluency and coherence of the generated text. By minimizing these loss functions, the quality and accuracy of the generated questions and answers are improved.

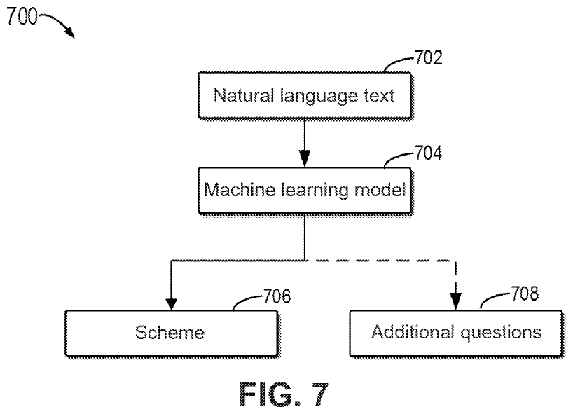

FIG. 7 illustrates a schematic diagram of a scenario of use 700 of a trained machine learning model according to embodiments of the present disclosure. After generating the machine learning model in the approach of FIG. 3 or after additionally completing the adjustment shown in FIG. 6, the generated machine learning model 704 can provide a scheme 706 that matches a natural language text 702 when it receives input of the natural language text, or ask additional questions 708 when an answer to the generated question fails to be obtained. This machine learning model can enhance the performance and efficiency of various types of customer services and increase the comfort level of customers when using them.

This trained machine learning model can be applied to the following scenarios. For example, a customer calls a technician to report a problem with their powered server. The technician needs to identify the cause of the problem and provide a solution or workaround. In this scenario, the machine learning model generated using the method of the present application has the following advantages.

First, the technician does not need to look up a decision tree corresponding to the powered server that the customer is asking questions about because it has already been encoded into the machine learning model. Second, since the machine learning model determines questions corresponding to nodes of the decision tree and acquires answers based on the graph neural network embedding and the inputted natural language text, the technician does not need to manually determine a path through the decision tree by asking each question and following each edge of the decision tree. Third, the technician does not need to adapt the questions and answers to the natural language and to edit the generated answers according to the specific situation of the customer, because the machine learning model produces fluent and coherent text customized to the needs of the customer.

In addition to the advantages described above, the machine learning models generated using the method of the present application also have higher accuracy, efficiency, consistency, and customer satisfaction compared with the prior art. Specifically, since the method of the present application uses the graph neural network embedding technique to capture the structure and semantics of a decision tree, and uses the machine learning model (e.g., a large language model such as GPT-3) generation technique to make use of the inputted natural language text and the large pre-trained knowledge, the accuracy of the question identification and resolution of the server is improved, which can reduce errors or inconsistencies that may be caused by manual lookup or navigation of the decision tree, or by manual adjustment or interpretation of the questions and answers, and can save time and effort that may be spent on storing or looking up the decision tree, or on manually interrogating and tracking the questions and answers. This can also enable the technician to provide the same quality of service and standard of service to different customers and in different situations, which allows for enhanced communication and interaction between customers and the technician, and increases the likelihood of finding and providing a satisfactory solution or workaround.

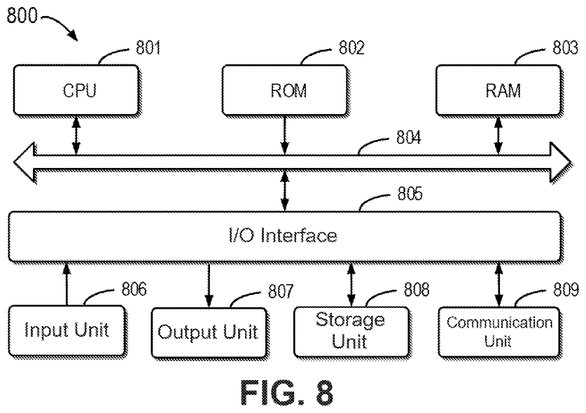

FIG. 8 illustrates a block diagram of an example device 800 that can be used to implement embodiments of the present disclosure. The electronic device in FIG. 1 can be implemented using the device 800. As shown in the figure, the device 800 includes a central processing unit (CPU) 801 that may execute various appropriate actions and processing according to computer program instructions stored in a read-only memory (ROM) 802 or computer program instructions loaded from a storage unit 808 to a random access memory (RAM) 803. In the RAM 803, various programs and data required for the operation of the device 800 may also be stored. The CPU 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; a storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The various processes and processing procedures described above, such as the method 200, may be performed by the CPU 801. For example, in some embodiments, the method 200 may be implemented as a computer software program that is tangibly included in a machine-readable medium, such as the storage unit 808. In some embodiments, part or all of the computer program may be loaded and/or installed onto the device 800 via the ROM 802 and/or the communication unit 809. One or more actions of the method 200 described above may be performed when the computer program is loaded into the RAM 803 and executed by the CPU 801.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for generating a machine learning model, comprising:
encoding a decision tree using a graph neural network;
inputting the encoded decision tree into a machine learning model;
generating a question corresponding to each node of a root node and internal nodes of the decision tree using the machine learning model;
inputting a natural language text to the machine learning model; and
generating the machine learning model using the inputted natural language text and the generated question.

2. The method according to claim 1, further comprising:
acquiring an answer to a question corresponding to the root node of the decision tree from the natural language text using the machine learning model;
determining, based on the answer to the question corresponding to the root node, a first internal node question corresponding to a first internal node that is a node at a next depth of the root node, and acquiring an answer to the first internal node question from the natural language text; and
repeating steps of acquiring an answer to a question corresponding to a current node from the natural language text and of determining a question corresponding to a node at a next depth based on the answer, until an answer to a question corresponding to a node at a previous depth of a leaf node of the decision tree is acquired from the natural language text, or an answer to a current question fails to be acquired from the natural language text.

3. The method according to claim 2, further comprising:
constructing a decision chain using the answers acquired from the natural language text and the corresponding questions;
comparing the decision chain with the decision tree; and
determining whether a path consistent with the decision chain exists in the decision tree.

4. The method according to claim 3, further comprising:
adjusting, in the case where no path consistent with the decision chain exists in the decision tree, the machine learning model using a loss function so as to minimize a path deviation between the decision tree and the decision chain.

5. The method according to claim 2, further comprising:
outputting, in the case where the answer to the current question fails to be acquired from the natural language text, a statement indicating that a scheme matching the natural language text fails to be found; and
outputting, in response to the answer to the question corresponding to the node at the previous depth of the leaf node being acquired from the natural language text, a scheme of the leaf node in the decision tree according to the answer to the question corresponding to the node at the previous depth of the leaf node.

6. The method according to claim 1, wherein encoding a decision tree using a graph neural network comprises:
converting the decision tree into a directional acyclic graph form; and
encoding the directional acyclic graph form into an embedding of the machine learning model using the graph neural network.

7. The method according to claim 2, further comprising:
outputting, after completion of the repeated steps, the answers acquired using the natural language text and the corresponding questions.

8. The method according to claim 1, further comprising:
inputting a target natural language text to the machine learning model; and
causing the machine learning model to output a scheme of a leaf node in the decision tree that matches the target natural language text.

9. The method according to claim 8, further comprising,
outputting, in the case where the machine learning model fails to find the scheme matching the target natural language text, an additional question required to find the scheme matching the target natural language text.

10. An electronic device, comprising:
a processor; and
a memory, the memory being coupled to the processor and storing instructions, wherein the instructions, when executed by the processor, cause the electronic device to perform the following actions:
encoding a decision tree using a graph neural network;
inputting the encoded decision tree into a machine learning model;
generating a question corresponding to each node of a root node and internal nodes of the decision tree using the machine learning model;
inputting a natural language text to the machine learning model; and
generating the machine learning model using the inputted natural language text and the generated question.

11. The electronic device according to claim 10, wherein the instructions when executed by the processor further cause the electronic device to perform the following actions:
acquiring an answer to a question corresponding to the root node of the decision tree from the natural language text using the machine learning model;
determining, based on the answer to the question corresponding to the root node, a first internal node question corresponding to a first internal node that is a node at a next depth of the root node, and acquiring an answer to the first internal node question from the natural language text; and
repeating steps of acquiring an answer to a question corresponding to a current node from the natural language text and of determining a question corresponding to a node at a next depth based on the answer, until an answer to a question corresponding to a node at a previous depth of a leaf node of the decision tree is acquired from the natural language text, or an answer to a current question fails to be acquired from the natural language text.

12. The electronic device according to claim 11, wherein the instructions when executed by the processor further cause the electronic device to perform the following actions:
constructing a decision chain using the answers acquired from the natural language text and the corresponding questions;
comparing the decision chain with the decision tree; and
determining whether a path consistent with the decision chain exists in the decision tree.

13. The electronic device according to claim 12, wherein the instructions when executed by the processor further cause the electronic device to perform the following action:
adjusting, in the case where no path consistent with the decision chain exists in the decision tree, the machine learning model using a loss function so as to minimize a path deviation between the decision tree and the decision chain.

14. The electronic device according to claim 11, wherein the instructions when executed by the processor further cause the electronic device to perform the following actions:
outputting, in the case where the answer to the current question fails to be acquired from the natural language text, a statement indicating that a scheme matching the natural language text fails to be found; and
outputting, in the case where the answer to the question corresponding to the node at the previous depth of the leaf node is acquired from the natural language text, a scheme in the leaf node in the decision tree according to the answer to the question corresponding to the node at the previous depth of the leaf node.

15. The electronic device according to claim 10, wherein encoding a decision tree using a graph neural network comprises:
converting the decision tree into a directional acyclic graph form; and
encoding the directional acyclic graph form into an embedding of the machine learning model using the graph neural network.

16. The electronic device according to claim 11, wherein the instructions when executed by the processor further cause the electronic device to perform the following action:
outputting, after completion of the repeated steps, the answers acquired using the natural language text and the corresponding questions.

17. The electronic device according to claim 10, wherein the instructions when executed by the processor further cause the electronic device to perform the following actions:
inputting a target natural language text to the machine learning model; and
causing the machine learning model to output a scheme of a leaf node in the decision tree that matches the target natural language text.

18. The electronic device according to claim 17, wherein the instructions when executed by the processor further cause the electronic device to perform the following action:
outputting, in the case where the machine learning model fails to find the scheme matching the target natural language text, an additional question required to find the scheme matching the target natural language text.

19. A computer program product tangibly stored on a non-transitory computer-readable storage medium and comprising computer-executable instructions, wherein the computer-executable instructions, when executed by a machine, cause the machine to perform the following actions:
encoding a decision tree using a graph neural network;
inputting the encoded decision tree into a machine learning model;
generating a question corresponding to each node of a root node and internal nodes of the decision tree using the machine learning model;
inputting a natural language text to the machine learning model; and
generating the machine learning model using the inputted natural language text and the generated question.

20. The computer program product according to claim 19, wherein the computer-executable instructions, when executed by the machine, further cause the machine to perform the following actions:
acquiring an answer to a question corresponding to the root node of the decision tree from the natural language text using the machine learning model;
determining, based on the answer to the question corresponding to the root node, a first internal node question corresponding to a first internal node that is a node at a next depth of the root node, and acquiring an answer to the first internal node question from the natural language text; and
repeating steps of acquiring an answer to a question corresponding to a current node from the natural language text and of determining a question corresponding to a node at a next depth based on the answer, until an answer to a question corresponding to a node at a previous depth of a leaf node of the decision tree is acquired from the natural language text, or an answer to a current question fails to be acquired from the natural language text.
